(19) United States
(12) Patent Application Publication
(10) Pub. No.: US 2026/0265028 A1
(43) Pub. Date: Sep. 10, 2026

(54) LIFTING APPARATUS AND LIFTING SYSTEM

(71) Applicant: ABB SCHWEIZ AG, Baden (CH)

(72) Inventors: Pushuang Xu, Shanghai (CN); Telmo Miguel Medina, Burgos (ES); Juan Bautista Lendrino Fernandez, Madrid (ES); Zhenghao Dong, Shanghai (CN); Zhijun Ding, Shanghai (CN)

(21) Appl. No.: 19/659,905

(22) Filed: Apr. 27, 2026

Related U.S. Application Data
(63) Continuation of application No. PCT/CN2023/127402, filed on Oct. 27, 2023.

(51) Int. Cl. B66F 7/06

(52) U.S. Cl. CPC B66F 7/0658; B66F 7/0608

(57) ABSTRACT

A lifting apparatus includes a base ; a supporting assembly, a first transmitting assembly a second transmitting assembly and an actuating assembly . The supporting assembly is configured to support an object thereon and lift the object to move in a lifting direction The first transmitting assembly is coupled to the base and the supporting assembly The second transmitting assembly is coupled to the base and the supporting assembly wherein first transmitting assembly and the second transmitting assembly are symmetrically provided with respect to a virtual plane parallel to the lifting direction The actuating assembly is coupled to the first and second transmitting assemblies and the actuating assembly is configured to actuate the first and second transmitting assemblies to move synchronously and symmetrically with respect to the virtual plane.

### FIELD

Example embodiments of the present disclosure generally relate to the industrial field, and more particularly, to a lifting apparatus and a corresponding lifting system.

### BACKGROUND

In the manufacturing industries, automated guided vehicles (AGVs) are becoming more and more widely used in various scenarios, such as transferring parts in factories or moving goods in warehouses. In the working process of AGV, a lifting movement of a lifting apparatus is an important function, which can lift a variety of goods to desired positions in a convenient manner.

In order to realize the lifting movement of AGV, a plurality of different mechanical structure forms can be adopted. However, the space structure is not compact and the cost is relatively high. In the actual applications, the details of the structure are also different, which limits the application scope of the approach.

### SUMMARY

In general, example embodiments of the present disclosure provide a lifting apparatus and a corresponding lifting system, which address the existing problems and/or any potential problems.

In a first aspect, there is provided a lifting apparatus. The lifting apparatus comprising: a base; a supporting assembly configured to support an object thereon and lift the object to move in a lifting direction; a first transmitting assembly coupled to the base and the supporting assembly; a second transmitting assembly coupled to the base and the supporting assembly, first transmitting assembly and the second transmitting assembly are symmetrically provided with respect to a virtual plane parallel to the lifting direction; and an actuating assembly coupled to the first and second transmitting assemblies, the actuating assembly being configured to actuate the first and second transmitting assemblies to move synchronously and symmetrically with respect to the virtual plane.

According to the example embodiments of the present disclosure, the compact structure and low cost of the lifting apparatus can be achieved, and the assembly and structural stability of the lifting apparatus can also be improved.

In some example embodiments, the first transmitting assembly comprises: a first pair of linkages having a first fixed pivot fixedly coupled to the supporting assembly and a first pair of rollers movably coupled to the base; and a second pair of linkages pivotably coupled to the first pair of linkages, the second pair of linkages having a second fixed pivot fixedly coupled to the base and a second pair of rollers movably coupled to the supporting assembly; and the second transmitting assembly comprises: a third pair of linkages having a third fixed pivot fixedly coupled to the supporting assembly and a third pair of rollers movably coupled to the base; and a fourth pair of linkages pivotably coupled to the third pair of linkages, the fourth pair of linkages having a fourth fixed pivot fixedly coupled to the base and a fourth pair of rollers movably coupled to the supporting assembly.

In some example embodiments, the first and second pair of rollers are provided closer to the virtual plane relative to the first and second fixed pivots; and the third and fourth pair of rollers are provided closer to the virtual plane relative to the third and fourth fixed pivots.

In some example embodiments, the actuating assembly is coupled to the first pair of linkages adjacent to the first pair of rollers and coupled to the third pair of linkages adjacent to the third pair of rollers.

In some example embodiments, the base comprises a base rail along which the first pair of rollers and the third pair of rollers can move.

In some example embodiments, the supporting assembly comprises: a supporting body configured to support the object; and a supporting rail along which the second pair of rollers and the fourth pair of rollers can move.

In some example embodiments, the first fixed pivot and the first pair of rollers are provided at opposite ends of the first pair of linkages; and the second fixed pivot and the second pair of rollers are provided at opposite ends of the second pair of linkages.

In some example embodiments, the third fixed pivot and the third pair of rollers are provided at opposite ends of the third pair of linkages; and the fourth fixed pivot and the fourth pair of rollers are provided at opposite ends of the fourth pair of linkages.

In some example embodiments, the first pair of linkages and the second pair of linkages are hinged to each other via a first connecting pivot at their middle sections; and the third pair of linkages and the fourth pair of linkages are hinged to each other via a second connecting pivot at their middle sections.

In some example embodiments, the actuating assembly comprises: a motor coupled to a shaft and configured to actuate the shaft to move linearly in two opposite directions perpendicular to the lifting direction; a first coupling coupled to the shaft and the first transmitting assembly; and a second coupling coupled to the shaft and the second transmitting assembly.

In a second aspect, there is provided a lifting system. The lifting system comprises a lifting apparatus in the first aspect.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a perspective view of the lifting apparatus in accordance with an example embodiment of the present disclosure; and

FIG. 2 illustrates an exploded view of the lifting apparatus in accordance with an example embodiment of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

A variety of approaches have been proposed to lift the objects to desired positions in goods transferring industry. The conventional approaches mainly use screw lifting structure or crank rocker lifting structure to lift the goods. As described above, these conventional approaches still have many disadvantages.

For example, for the screw lifting structure, the space utilization rate is relatively low, and the use of compact space will be limited. In addition, the processing cost of the screw lifting mechanism with large lift is relatively high. The parts of the screw are generally made of alloy steel, with a large amount of heat treatment and grinding, and the material cost and processing cost are relatively high. The screw having a hollow structure is also difficult to process, the quality stability is poor, the cost is high, and it is difficult to apply the eccentric force.

For the crank rocker lifting structure, since the number of parts is large, it is inconvenient for installation and maintenance. Moreover, there may be over constrain for the existing crank rocker lifting structure, the dimensional tolerance of the parts is high to ensure the precise assembly. Worse still, in order to ensure assembly, the dimensional accuracy of the parts is high, and it is not easy to install and maintain. The driving force required is large, especially in the initial stage, and the corresponding large torque reducer size is large. Some lifting mechanisms adopt a single set of scissor lever mechanism, which has poor stability after being raised to the end of the stroke.

At least to address the problem existed in the conventional approaches, the present disclosure proposes a solution involving a lifting apparatus and a corresponding lifting system, which greatly saves the space occupied by the lifting apparatus and achieves a higher performance.

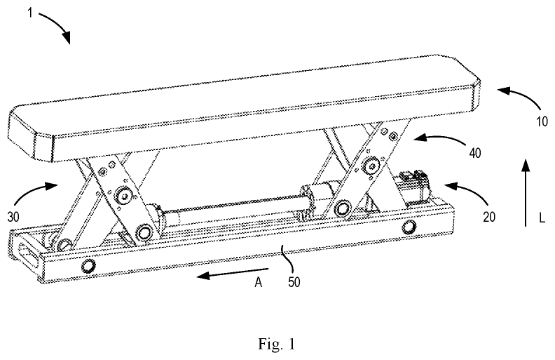

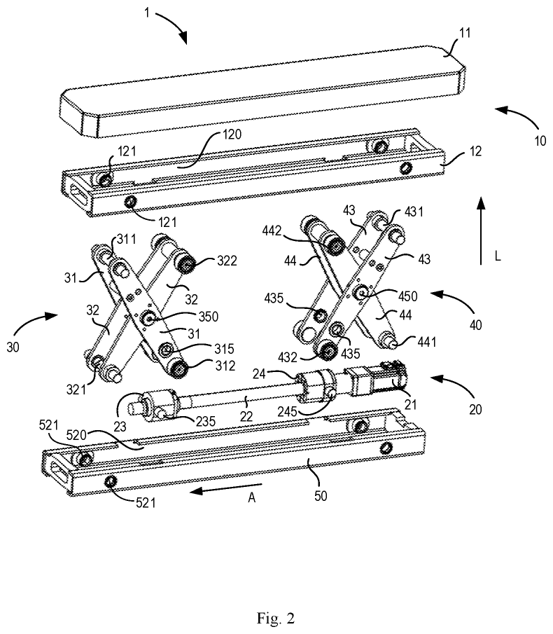

Example embodiments of the present disclosure will be described in more detail hereinafter in accordance with FIGS. 1-2, wherein FIG. 1 illustrates a perspective view of the lifting apparatus 1 in accordance with an example embodiment of the present disclosure, and FIG. 2 illustrates an exploded view of the lifting apparatus 1 in FIG. 1.

The lifting apparatus 1 generally includes a base 50, a supporting assembly 10 and two transmitting assemblies 30, 40 coupled to the base 50 and the supporting assembly 10. The supporting assembly 10 may include a supporting body 11 which is configured to support an object (not shown) on its top surface 110. By means of the lifting apparatus 1, the object can be moved to desired height. The object can be any type of objects that are intended to be supported or delivered by the lifting apparatus 1. The specific type and the shape of the object are not limited to embodiments of the present disclosure.

The supporting assembly 10 may also include a frame 12 for connecting to the two transmitting assemblies 30, 40. The lifting apparatus 1 is designed to lift the object on the top surface 110 to move in a lifting direction L. It is to be understood that the object on the top surface 110 can also be lower down in its height along a direction opposite to the lifting direction L.

The two transmitting assemblies 30, 40 are symmetric about a virtual plane parallel to the lifting direction L, which will be described in more details hereinafter. The virtual plane herein can also be understood as a central plane between the two transmitting assemblies 30, 40.

The actuating assembly 20 is fixedly mounted to the base 50 and coupled to the first and second transmitting assemblies 30, 40. The actuating assembly 20 includes a motor 21. The motor 21 is coupled to a shaft 22 and configured to actuate the shaft 22 to spin along its own central axis. The central axis of the shaft 22 may be perpendicular to the lifting direction L. In the shown embodiments, the central axis of the shaft 22 can also be regarded as being parallel to a normal vector of the virtual plane.

As can be seen from FIG. 2, the first transmitting assembly 30 may include a first pair of linkages 31 and a second pair of linkage 32, which are hinged to each other via a first connecting pivot 350. It is to be understood that even though the first connecting pivot 350 is shown to be in the middle of the respective linkage, this is only illustrative, rather than restrictive. As shown, the first pair of linkages 31 have a first fixed pivot 311 at its one end and have a first pair of rollers 312 at the other end opposite to the first fixed pivot 311. The first fixed pivot 311 is fixedly coupled to the supporting assembly 10, for example, the first fixed pivot 311 may insert into the holes 121 provided at the frame 12 of the supporting assembly 10, such that the first pair of linkages 31 may rotate relative to the supporting assembly 10 about the first fixed pivot 311.

The first pair of rollers 312 may be movably coupled to the base 50. In the shown embodiments, the base 50 includes a base rail 520 to allow the first pair of rollers 312 to move along.

As can be seen from FIG. 2, the second pair of linkages 32 may include a second fixed pivot 321 at its one end and have a second pair of rollers 322 at the other end opposite to the second fixed pivot 321. The second fixed pivot 321 is fixedly coupled to the base 50, for example, the second fixed pivot 321 may insert into the holes 521 provided at base 50, such that the second pair of linkages 32 may rotate relative to the base 50 about the second fixed pivot 321.

The second pair of rollers 322 may be movably coupled to the frame 12 of the supporting assembly 10. In the shown embodiments, the frame 12 includes a supporting rail 120 to allow the second pair of rollers 322 to move along.

The second transmitting assembly 40 has the similar configuration to the first transmitting assembly 30. The second transmitting assembly 40 includes a third pair of linkages 43 and a fourth pair of linkages 44 which are hinged to each other via a second connecting pivot 450. It is to be understood that even though the second connecting pivot 450 is shown to be in the middle of the respective linkage, this is only illustrative, rather than restrictive.

The third pair of linkage 43 include a third fixed pivot 431 fixedly coupled to the supporting assembly 10 and a third pair of rollers 432 movably coupled to the base 50. The fourth pair of linkages 44 includes a fourth fixed pivot 441 fixedly coupled to the base 50 and a fourth pair of rollers 442 movably coupled to the supporting assembly 10. The connections among the second transmitting assembly 40, the base 50 and the supporting assembly 10 are similar to those among the first transmitting assembly 30, the base 50 and the supporting assembly 10, which will be omitted herein for brevity.

As can be seen from FIGS. 1-2, the first and second pair of rollers 312, 322 are provided closer to the virtual plane relative to the first and second fixed pivots 311, 321 and the third and fourth pair of rollers 432, 442 are provided closer to the virtual plane relative to the third and fourth fixed pivots 431, 441.

The connections among the first and second transmitting assemblies 30, 40 and the actuating assembly 20 will be described below.

As can be seen from FIG. 2, the actuating assembly 20 includes a first coupling 23 and a second coupling 24, which are coupled to the shaft 22. The first coupling 23 may include a first bulge 235, and the second coupling 24 may include a second bulge 245. Correspondingly, the first pair of linkages 31 may include a first connecting hole 315 adjacent to the first pair of rollers 312 and the third pair of linkages 43 may include a second connecting hole 435 adjacent to the third pair of rollers 432. When the motor 21 is driven, the shaft 22 of the motor 21 may spin along its central axis. The actuating assembly 20 is configured such that when the shaft 22 of the motor 21 is driven to spin along its central axis, the first coupling 23 and the second coupling 24 may be moved closer to each other or further away from each other. For example, when the first coupling 23 move towards the left direction in FIG. 2 (along the arrow A), the second coupling 24 can move towards the right direction (opposite to the arrow A) to allow the first and second couplings 23, 24 to move further away from each other. When the first coupling 23 move towards the right direction (opposite to the arrow A) in FIG. 2, the second coupling 24 can move towards the left direction (along the arrow A) to allow the first and second couplings 23, 24 to move closer to each other. The first bulge 235 may insert into the first connecting hole 315 and the second bulge 245 may insert into the second connecting hole 435. In this manner, when the shaft 22 is actuated to move, the first bulge 235 and the second bulge 245 may actuate the first pair of linkages 31 and the second pair of linkages 43 to rotate simultaneously.

It is to be understood that the number of the transmitting assemblies is merely example without suggesting any limitation as to the scope of the present disclosure. In other example embodiments, according to the actual need of users, more transmitting assemblies can be provided, for example, four, six and even more.

In the illustrated embodiment, the two transmitting assemblies 30, 40 are of the same shape and may be different from each other only in their specific locations. In this manner, the two transmitting assemblies 30, 40 may move synchronously with a same pace. As a result, the supporting assembly 10 can be kept horizontally in operation to avoid the object on it from being fallen.

The example working procedure of the lifting apparatus 1 will be described in detail below with reference to FIGS. 1-2.

The lifting of the object is powered by the actuation of the motor 21. When the motor 21 rotates, the shaft 22 can be actuated to spin along its own central axis. As a result, the first bulge 235 of the first coupling 23 can move along the arrow A and the second bulge 245 of second coupling 24 can move opposite to the arrow A. The movement of the first bulge 235 along the arrow A will cause the first pair of rollers 312 to move leftwards, and the second pair of rollers 322 will move leftwards accordingly, so as to make the first transmitting assembly 30 be become higher. The movement of the second bulge 245 opposite the arrow A will cause the third pair of rollers 432 to move rightwards, and the fourth pair of rollers 442 will move rightwards accordingly, so as to make the second transmitting assembly 40 be become higher as well. In this manner, the first transmitting assembly 30 and the second transmitting assembly 40 can be actuated to move synchronously to ensure a secure lifting. It is to be understood that the above working procedure is described as to the lifting of the object, the lower down of the object can be achieved in an opposite manner. The detailed description of the lowering down of the object will be omitted for brevity.

In the existing solution where the second transmitting assembly 40 is entirely the replica of first transmitting assembly 30 (instead of being symmetrically with respect to the virtual plane), when the object is being lifted, all the pivot will move in the same direction, for example along the arrow A, and the center of the gravity will not be remained in the middle plane of the lifting apparatus 1. Therefore, the stability of the existing lifting apparatus is worse.

In a contrast, in the solution proposed herein, as can be seen from FIG. 2, the first and second pair of rollers 312, 322 are provided closer to the virtual plane relative to the first and second fixed pivots 311, 321 and the third and fourth pair of rollers 432, 442 are provided closer to the virtual plane relative to the third and fourth fixed pivots 431, 441; that is, all the rollers 312, 322, 432, 442 are located at an inner side of the lifting apparatus 1. In other words, the first transmitting assembly 30 and the second transmitting assembly 40 are symmetrically provided with respect to the virtual plane, which is parallel to the lifting direction L and perpendicular to the arrow A. Since the first transmitting assembly 30 and the second transmitting assembly 40 are symmetrically provided with respect to the virtual plane, when the object is being lifted, the center of the gravity will still be remained in the middle plane of the lifting apparatus 1. Therefore, the stability of the existing lifting apparatus 1 according to example embodiment of the present disclosure is good. As all the total eight supporting joints (including the first, second, third, fourth fixed pivots 311, 321, 431, 441 and the first, second, third, fourth pairs of rollers 312, 322, 432, 442) of two transmitting assemblies 30, 40 are at the far end of both the supporting body 11 and the base 50, which will not move inwardly during the lifting process, thus ensuring the stability of the whole lifting apparatus 1.

In addition, a pair of internal forces (action force and reaction force) are used to drive the two transmitting assemblies 30, 40 at the same time, which is more efficient. In the case of lifting the same object, only half of the driving force of the motor 21 is needed, compared to the existing lifting apparatus. As a result, the size of the actuating assembly 20 can be more compact including those dimensions of the shaft 22, the motor 21 and the related drivetrain; and lower current of the motor 21 is required. The design of the whole lifting apparatus 1 is more compact, the cost is lower, and the installation and maintenance are more convenient.

In a second aspect, there is provided a lifting system. The lifting system comprises a lifting apparatus 1 described above.

Compared with the conventional approaches, the example embodiments according to the present disclosure has higher performance and is more balanced. Moreover, since the driving force of the actuating assembly can be reduced to a half, a compact structure with lower cost can be achieved. A modular design easier to assemble and maintain can also be achieved. It is to be understood that although the above disclosure is described by taking the object transferring scenario as examples, this is only for illustration without suggesting any limitations as to the scope of the subject matter described here the above embodiments may be used in other scenarios.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A lifting apparatus comprising:
a base;
a supporting assembly configured to support an object thereon and lift the object to move in a lifting direction;
a first transmitting assembly coupled to the base and the supporting assembly;
a second transmitting assembly coupled to the base and the supporting assembly, wherein first transmitting assembly and the second transmitting assembly are symmetrically provided with respect to a virtual plane parallel to the lifting direction; and
an actuating assembly coupled to the first and second transmitting assemblies the actuating assembly being configured to actuate the first and second transmitting assemblies to move synchronously and symmetrically with respect to the virtual plane.

2. The lifting apparatus according to claim 1, wherein the first transmitting assembly comprises:
a first pair of linkages having a first fixed pivot fixedly coupled to the supporting assembly and a first pair of rollers movably coupled to the base; and
a second pair of linkages pivotably coupled to the first pair of linkages the second pair of linkages having a second fixed pivot fixedly coupled to the base and a second pair of rollers movably coupled to the supporting assembly; and
wherein the second transmitting assembly comprises:
a third pair of linkages having a third fixed pivot fixedly coupled to the supporting assembly and a third pair of rollers movably coupled to the base; and
a fourth pair of linkages pivotably coupled to the third pair of linkages the fourth pair of linkages having a fourth fixed pivot fixedly coupled to the base and a fourth pair of rollers movably coupled to the supporting assembly

3. The lifting apparatus according to claim 2,
wherein the first and second pair of rollers are provided closer to the virtual plane relative to the first and second fixed pivots; and
wherein the third and fourth pair of rollers are provided closer to the virtual plane relative to the third and fourth fixed pivots.

4. The lifting apparatus according to claim 2, wherein the actuating assembly is coupled to the first pair of linkages adjacent to the first pair of rollers and coupled to the third pair of linkages adjacent to the third pair of rollers

5. The lifting apparatus according to claim 2, wherein the base comprises a base rail along which the first pair of rollers and the third pair of rollers can move.

6. The lifting apparatus according to claim 2, wherein the supporting assembly comprises:
a supporting body configured to support the object; and
a supporting rail along which the second pair of rollers and the fourth pair of rollers can move.

7. The lifting apparatus according to claim 2, wherein the first fixed pivot and the first pair of rollers are provided at opposite ends of the first pair of linkages; and
wherein the second fixed pivot and the second pair of rollers are provided at opposite ends of the second pair of linkages.

8. The lifting apparatus according to claim 2, wherein the third fixed pivot and the third pair of rollers are provided at opposite ends of the third pair of linkages; and
wherein the fourth fixed pivot and the fourth pair of rollers are provided at opposite ends of the fourth pair of linkages.

9. The lifting apparatus according to claim 2, wherein the first pair of linkages and the second pair of linkages are hinged to each other via a first connecting pivot at their middle sections; and
wherein the third pair of linkages and the fourth pair of linkages are hinged to each other via a second connecting pivot at their middle sections.

10. The lifting apparatus according to claim 1, wherein the actuating assembly comprises:
a motor coupled to a shaft and configured to actuate the shaft to move linearly in two opposite directions perpendicular to the lifting direction;
a first coupling coupled to the shaft and the first transmitting assembly; and
a second coupling coupled to the shaft and the second transmitting assembly.

11. A lifting system comprising the lifting apparatus according to claim 1.
